(19) United States
(12) Patent Application Publication
(10) Pub. No.: US 2012/0007301 A1
(43) Pub. Date: Jan. 12, 2012

(54) Worktable and its Protective Member

(76) Inventor: James Liu, Ta-Li (TW)

(21) Appl. No.: 12/833,046

(22) Filed: Jul. 9, 2010

(51) Int. Cl. B25H 1/02; B25H 1/14; B23D 45/06

(52) U.S. Cl. 269/309; 83/477.2

(57) ABSTRACT

A worktable includes a protective member designed therefor. The worktable includes a platform, and at least one extended platform connected thereto. The protective member includes a frame and a base connected on a bottom edge of the frame. The base including a first base section on which the platform is supported and at least one second base section on which the at least one extended platform is supported. The frame includes a periphery enclosing the platform and the at least one extended platform so as to prevent them from being damaged.

### BACKGROUND OF THE INVENTION

1. Field of the Invention

The present invention relates to a worktable for a machine and, in particular, to a worktable with a protective member.

2. Description of the Related Art

DIY (Do-it-yourself) is a trend in the United States and buying a woodworking machine for performing processing work on a desired wood workpiece is common for many families. Generally, a woodworking machines includes a worktable made of cast iron and on which a wood workpiece is set during the processing thereof. However, such cast-iron made worktable is fast becoming unsatisfactory because it is liable to expand when hot and to shrink when cold. Consequently, the deformed worktable would lose its flatness and adversely affect a user to operably move and process the wood workpiece set thereon precisely.

Then, a worktable which is made of stone is invented. Refer to China Pat. No. 200720148202.6, a worktable for a wood working machine is characterized by including an extended platform made of stone. While the stone made extended platform provides a satisfactory flatness, manufacturing it is difficult and costly and it is likely to have cracks during the manufacture thereof. Additionally, it is understood that if a stone is hit by an external object a chip could subsequently occur on an outer periphery thereof. Therefore, if something hits the extended platform accidentally its appearance could be damaged and the processing operation of the wood workpiece is affected.

The present invention is, therefore, intended to obviate or at least alleviate the problems encountered in the prior art.

### SUMMARY OF THE INVENTION

According to the present invention, a worktable with a protective member designed therefor includes a platform including a top surface, a lateral surface, and a bottom surface; at least one extended platform including a top surface, an inner lateral surface, an outer lateral surface and a bottom surface, and with the inner lateral surface connected to the lateral surface of the platform; and a frame and a base connected on a bottom edge of the frame, and with the base including a first base section and at least one second base section. In addition, the bottom surface of platform is supported on the first base section and the bottom surface of the at least one extended platform is supported on the second base section, and the frame includes a periphery enclosing the platform and the at least one extended platform so as to prevent them from being damaged and as such the outer lateral surface of the at least one extended is protected. Furthermore, the top surface of the at least one extended platform and the top surface of platform are at the same height such that the at least one platform cooperates with the platform to form a flat and level work surface that allows a workpiece to be set thereon, and with the at least one extended platform being adjustable in height to enable its top surface being flush and level with the top surface of platform.

### BRIEF DESCRIPTION OF THE DRAWINGS

FIG. 1 is a perspective view of a worktable and its protective member in accordance with a first embodiment of the present invention.

FIG. 2 is an exploded perspective view of the worktable and its protective member embodying the present invention shown in FIG. 1.

FIG. 3 is another exploded perspective view, taken from a different angle of view, of the worktable and its protective member embodying the present invention shown in FIG. 1.

FIG. 4 is a cross-sectional view of the worktable and its protective member embodying the present invention taken along line 4-4 of FIG. 1.

FIG. 5 is a cross-sectional view of the worktable and its protective member embodying the present invention taken along line 5-5 of FIG. 1.

FIG. 6 is a cross-sectional view of the worktable and its protective member embodying the present invention taken along line 6-6 of FIG. 4.

FIG. 7 is a partial, enlarged view of FIG. 6.

FIG. 8 shows the installation of an extended platform of the worktable on the protective member.

FIG. 9 shows a machine including the worktable and protective member embodying the present invention shown in FIG. 1.

FIG. 10 is a partial exploded view showing the assembly of a table insert on a platform of the worktable embodying the present invention shown in FIG. 1.

FIG. 11 is a cross-sectional view of the worktable and its protective member shown in FIG. 10.

FIG. 12 is an extended view of FIG. 5 and differentiates from FIG. 5 in that adjusting members are abutted against magnets.

FIG. 13 shows a worktable and its protective member in accordance with a second embodiment of the present invention for a jointer.

FIG. 14 is an exploded perspective view of the worktable and its protective member embodying the present invention shown in FIG. 13.

FIG. 15 is another exploded perspective view, taken from a different angle of view, of the worktable and its protective member embodying the present invention shown in FIG. 14.

### DETAILED DESCRIPTION OF THE PREFERRED EMBODIMENT

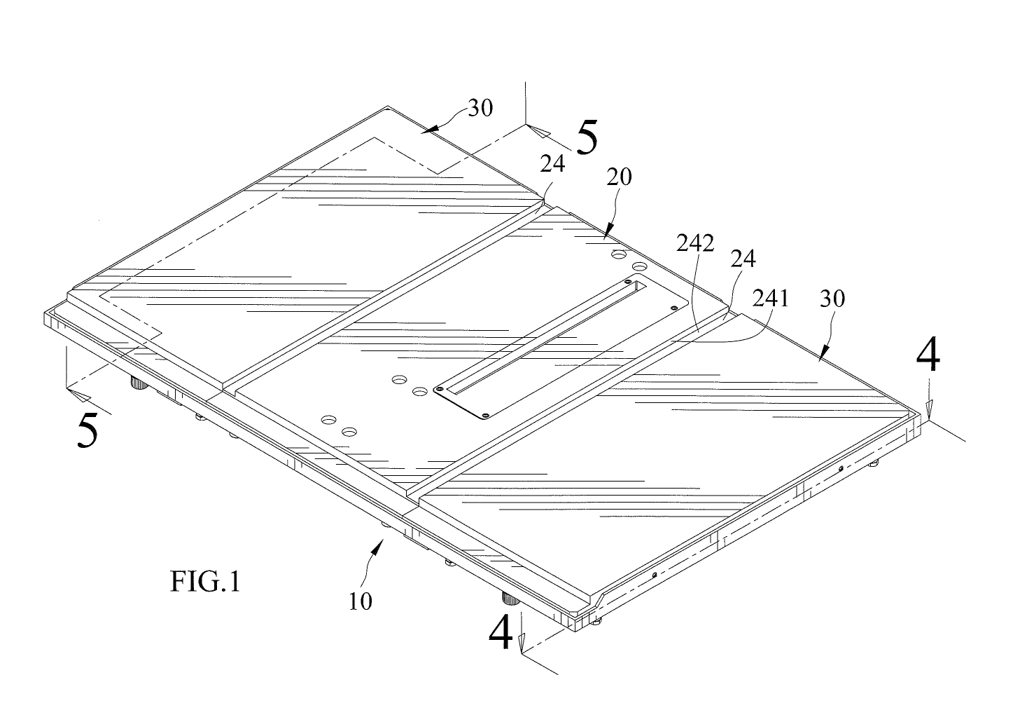

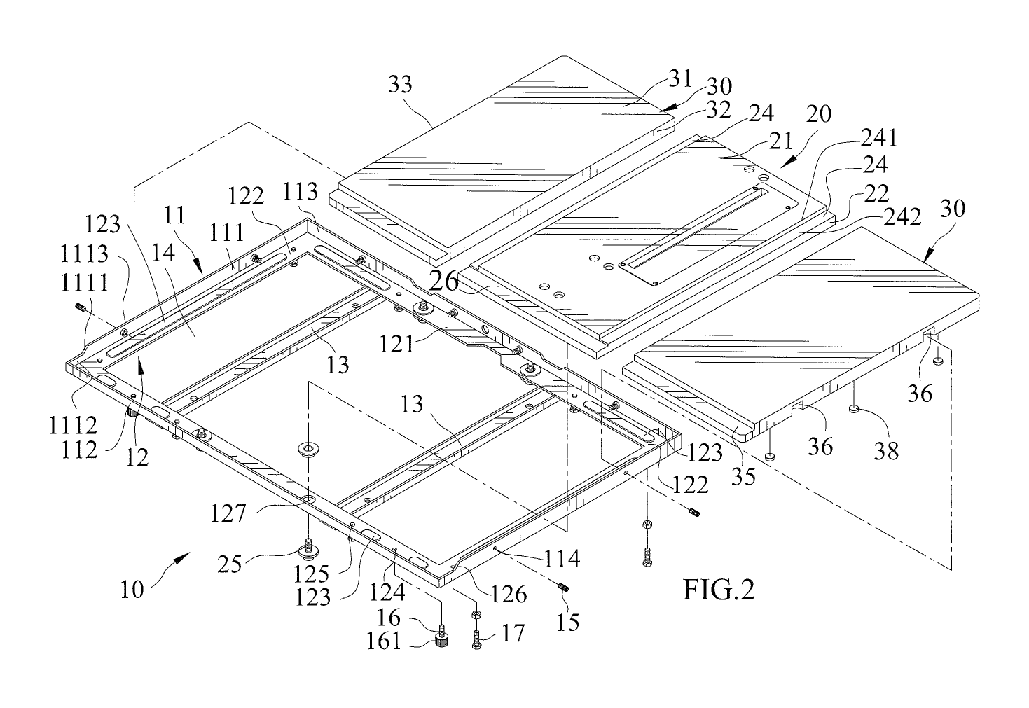

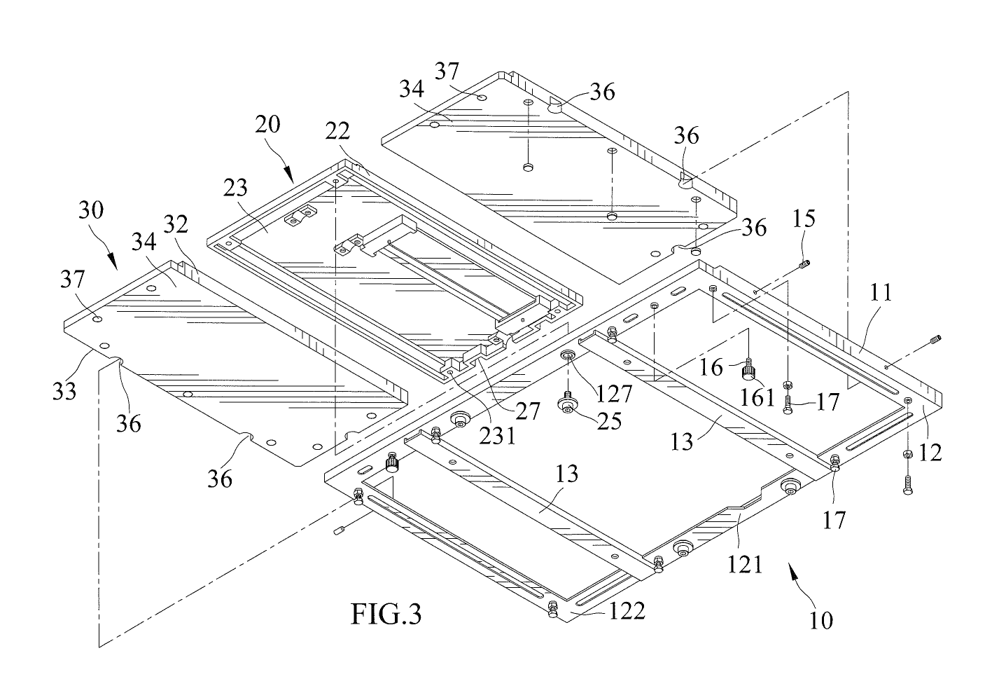

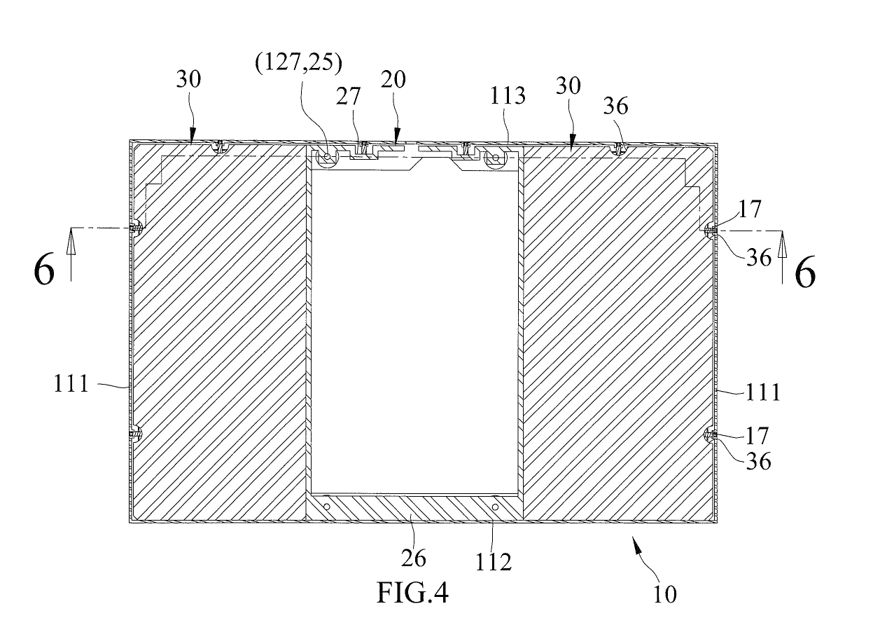

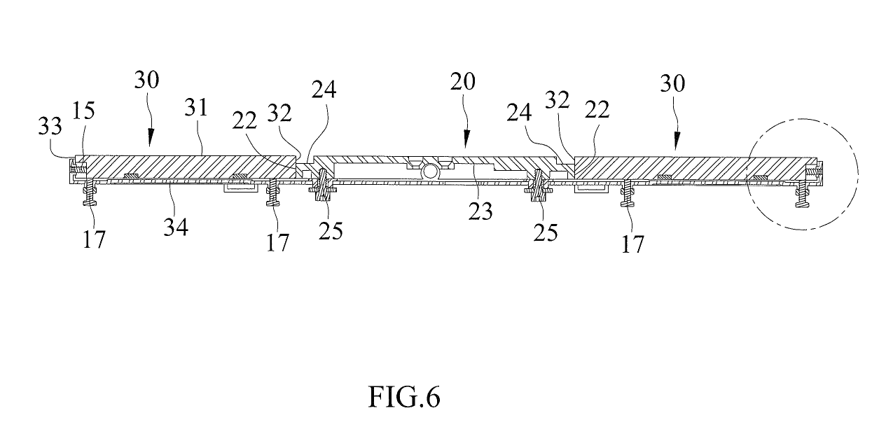

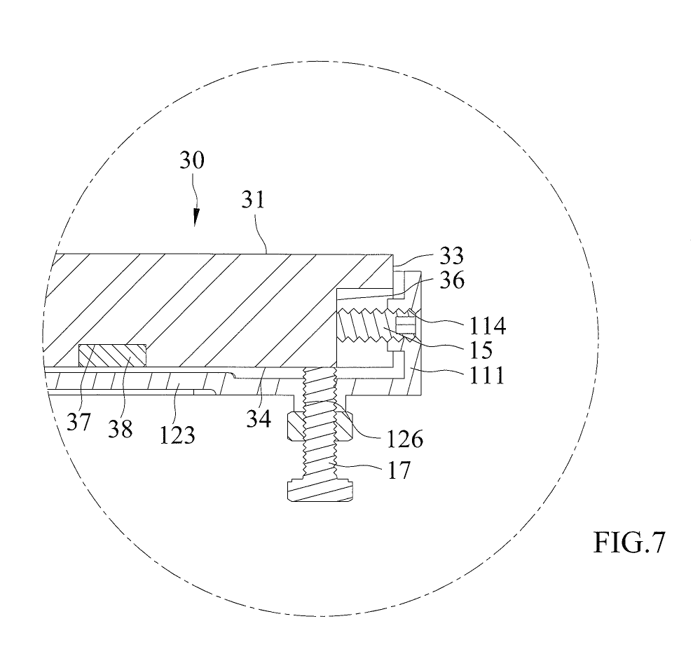

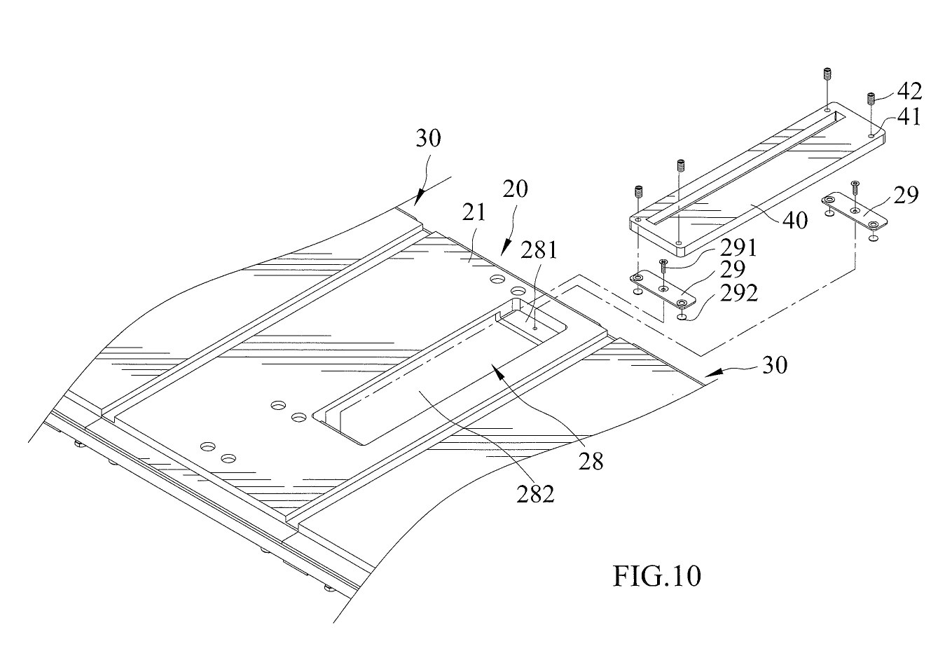

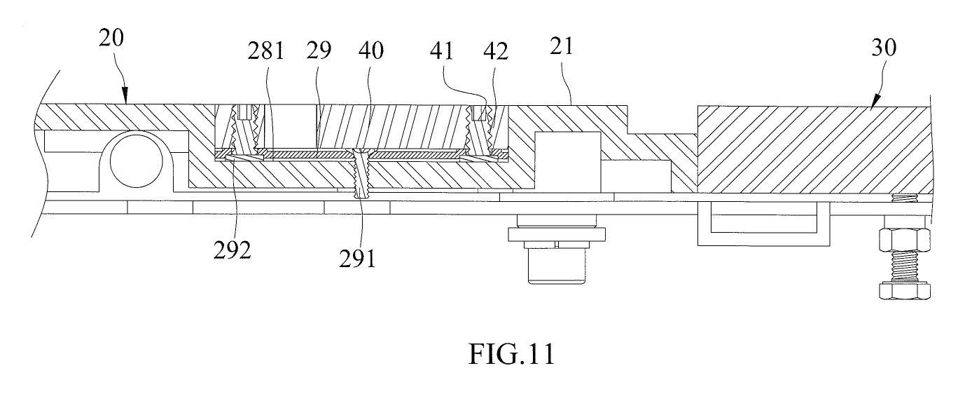

FIGS. 1 through 12 disclose a worktable including a protective member 10 designed therefor in accordance with a first embodiment of the present invention. The worktable includes a platform 20 and two extended platforms 30. The platform 20 includes two opposing lateral surfaces 22. Two extended platforms 30 are connected to the platform 20, with one connected to one of two lateral surfaces 22 of the platform 20 and the other connected to the other lateral surface 22 of the platform 20. Therefore, the platform 20 is disposed between the two extended platforms 30. Also, the platform 20 is made of metal and the extended platforms 30 are made of stone. In this embodiment, the extended platforms 30 are made of marble.

The platform 20 has a top surface 21 defining a work surface and each extended platforms 30 has a top surface 31 defining a work surface. The top surfaces 21 and 31 are at the same height such that they form a flat and level work surface.

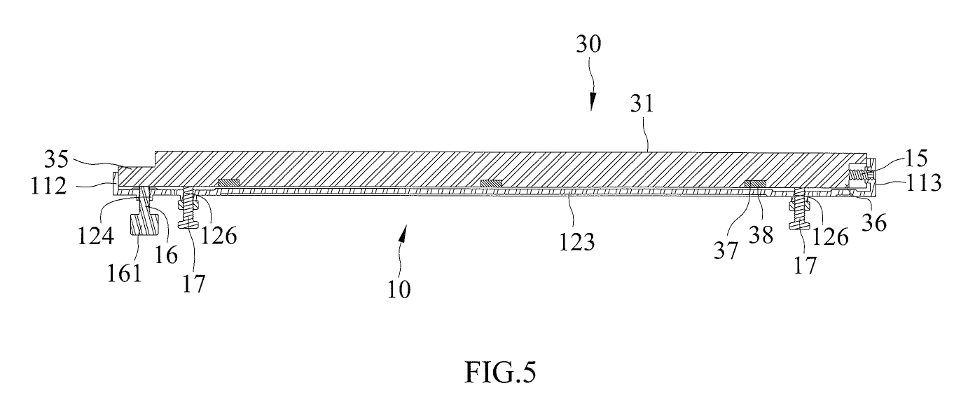

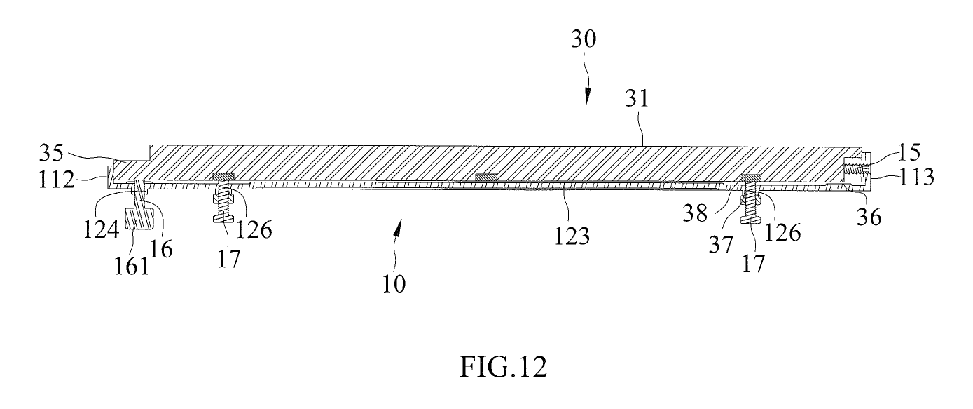

The protective member 10 includes a frame 11, a base 12, and a reinforcing rib 13. The frame 11 includes a space 14 delimited by a periphery thereof. In the embodiment, the periphery of the frame 11 encloses a rectangular area that delimits the space 14, and the periphery includes two lateral walls 111 opposing to each other, a front wall 112 and a back wall 113 opposing to the front wall 112, and the front 112 and back 113 walls extend between the two lateral walls 112. The base 12 is extended on a bottom edge of the frame 11. Consequently, the frame 11 has a top edge at a height above the base 12. Also, the base 12 extends along the periphery of the frame 11 and includes a supporting edge defined within the periphery of the frame 11. The supporting edge is utilized to support the platform 20 and two extended platforms 30 after the worktable is installed on the protective member 10. Specifically, the base 12 defines a first base section 121 supporting the platform 20 and two second base sections 122 supporting the two extended platforms 30, respectively. The base 12 further includes three protruded areas 123 defined on each second base section 122, with one disposed adjacent to the lateral wall 111 and another disposed adjacent to the front wall 112 and the other disposed adjacent to the back wall 113. The three protruded areas 123 are utilized to magnetically attract with three magnets 38 embedded in the associated extended platform 30, respectively. Additionally, the three magnets 38 are disposed corresponding to the protruded areas 123, respectively. Therefore, the magnets 38 provide for the associated extended platform 30 magnetic attractions with the protective member 10. It is understood that for each extended platform 30 the magnets 38 embedded therein can attract any metal part in connection with the protective member 10 otherwise to retain the extended platform 30 to the protective member 10. Preferably, the extended platform 30 includes cavities 37 defined in a bottom surface 34 thereof and each magnet 38 is embedded in one cavity 37. In addition, the base 12 includes a first through hole 124, at least one second through hole 125 and at least one third through hole 126 defined in each second base section 122. A buffering member 16 is adjustably engaged in the first through hole 124 and abuts against a bottom surface 34 of the extended platform 30, with the bottom surface 34 opposing to the top surface 31. Preferably, the buffering member 16 is threadly engaged in the first through hole 124. Also, the buffering member 16 includes a head 161 that allows a user to adjust the buffering member 16 by hand directly. Each of the at least one second 125 and third 126 through holes includes an adjusting member 17 adjustably engaged therein. The adjusting members 17 abut against bottom surfaces 34 of the extended platforms 30 (as shown in FIG. 5) or the magnets 38 (as shown in FIG. 12) to allow a user to adjust and make the top surface 31 of extended platform 30 flush and level with the top surface 21 of platform 20. Preferably, each adjusting member 17 is threadly engaged in the associated one of the second 125 or third 126 through holes. In the embodiment, the base 12 includes two second through holes 125 disposed adjacent to the first base section 121, with one disposed adjacent to the front wall 112 and the other disposed adjacent to the back wall 113, and two third through holes 126 disposed adjacent to the lateral wall 111 and are separated by the protruded area 123 that is defined adjacent to the associated lateral wall 111.

The base 12 further includes at least one through orifice 127 defined in the first base section 121. An engaging member 25 is inserted through the at least one through orifice 127 and engaged in an engaging hole 231 defined in a bottom surface 23 of the platform 20 to securely hold the platform 20 on the protective member 10. In the embodiment, the base 12 includes four through orifices 127 disposed corresponding to four engaging holes 231 respectively, and on four corners of the platform 20, with two disposed adjacent to one lateral surface 22 of the platform 20 and the other two disposed adjacent to the other lateral surface 22 of the platform 20, and with the two through orifices 127 disposed adjacent to the front wall 112 and the other two disposed adjacent to the back wall 113. The reinforcing ribs 13 enhance the structure of the protective member 10 and also support the extended platforms 30. In the embodiment, two reinforcing ribs 13 are provided on the protective member 10 to support the two extended platforms 30, respectively. Each of the reinforcing ribs 30 extends from the front wall 112 to the back wall 113 of frame 11 and is connected between a portion of the base 12 adjacent to the front wall 112 and a portion of the base 12 adjacent to the back wall 113.

In addition, the front wall 112 has a top edge at a height above the base 12 and the back wall 113 has a top edge at a height above the base 12 and greater than that of the front wall 112. Likewise, each lateral wall 111 has a top edge at a height above the base 12 and defines a guiding surface 1111, a first lateral wall section 1112 having a top edge at a height equaling to that of the front wall 112, and a second lateral wall section 1113 having a top edge at a height equaling to that of the back wall 113, with the guiding surface 1111 extending from the top edge of first lateral wall section 1112 to the top edge of second lateral wall section 1113.

The frame 11 further includes a plurality of apertures 114 defined therein and each is provided for a securing member 15 to insert to fit the platform 20 and extended platforms 30 on and within the protective member 10 securely. The securing members 15 prevent the platform 20 and extended platforms 30 from moving relative to one another and are adapted to fit within the periphery of the frame 11 such that they do not expose outside the periphery of the frame 11.

The platform 20 further includes two channels 24 defined therein and disposed adjacent to the two lateral surfaces 22, respectively. Each channel 24 extends longitudinally and along the associated lateral surface 22 and includes a lateral edge 241 and a bottom edge 242, with the bottom edge 242 being at a height lower than that of the top surface 21, with the lateral edge 241 extending from the top surface 21 to the bottom edge 242, and with the bottom edge 242 extending from the lateral edge 241 to the associated lateral surface 22. Therefore, the platform 20 includes its top surface 21 disposed between the two channels 24. Consequently, the two channels 24 will not affect a flatness of top surface 21 of the platform 20, thereby allowing a workpiece to be processed accurately, conveniently and in a cost-saving manner. Further, a protractor (not shown) is adapted to be moveably disposed in one channel 24 and is prevented from disengagement therefrom. The protractor would aid the positioning of a workpiece on the worktable so as to allow the workpiece to be positioned precisely.

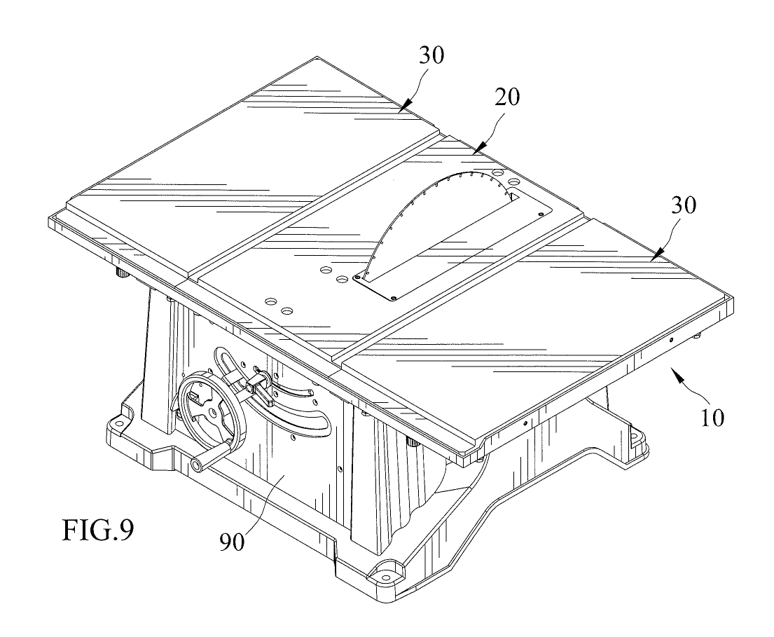

In addition, the platform 20 includes a front side 26 disposed adjacent to the front wall 112 and a back side (not numbered) disposed adjacent to the back wall 113, respectively. The front side 26 includes a top edge at a height lower than that of the top surface 21 and a side edge extending from the top surface top surface 21 to the top edge. The front side 26 allows a user to grasp when putting the platform 20 on the protective member 10. The back side includes a recessed area 27 defined thereon and disposed corresponding to one aperture 114 and the securing member 15 inserted in that aperture 114 abuts against a wall of the recessed area 27 to fit the platform 20 on the protective member 10. Additionally, the securing member 15 is adapted to be received by the recessed area 27 and fit within the periphery of the frame 11 such that it does not expose outside the periphery of the frame 11. In the embodiment, the platform 20 includes two recessed areas 27. The platform 20 further includes a slot 28 defined in the top surface 21. A table insert 40 for receiving a cutting device is embedded in the slot 28. The table insert 40 is supported by two supporting portions 281 defined at two distal ends of the slot 28. Further, an opening 282 is defined in the slot 28 and is disposed between the two supporting portions 281. The opening 282 allows a cutting member of the cutting device (not numbered) to insert through and expose outside the table insert 40, as shown in FIG. 9. Additionally, the table insert 40 is detachably secured in the slot 28 and can be disengaged therefrom without the use of any tool, so the table insert 40 is adapted to be taken out of the platform 20 conveniently and quickly for changing the cutting member and for cleaning dust. Specifically, two fixing seats 29 are mounted on two supporting portions 281, respectively, and each disposed between a bottom of the table insert 40 and a top of the associated supporting portion 281. Also, each fixing seat 29 is prevented from disengagement from the associated supporting portion 281 by a fastener 29 threadly engaged in the fixing seat 29 and supporting portion 281. At least one magnet 292 is embedded in each fixing seat 29. In the embodiment, each fixing seat 29 includes two magnets 292 embedded therein. The magnet 29 has two distal ends being opposite to one another, with one being flush with a top of the fixing seat 29 and the other being flush with a bottom of the fixing seat 29. Further, a regulating member 42 is adjustably embedded in an engaging orifice 41 defined in the table inset 40 and disposed corresponding to and magnetically attracted by the at least one magnet 292 to keep the table insert 40 retained in the slot 28. The regulating member 42 is adjustable to make a top of the table insert 40 flush with the top surface 21 of platform 20.

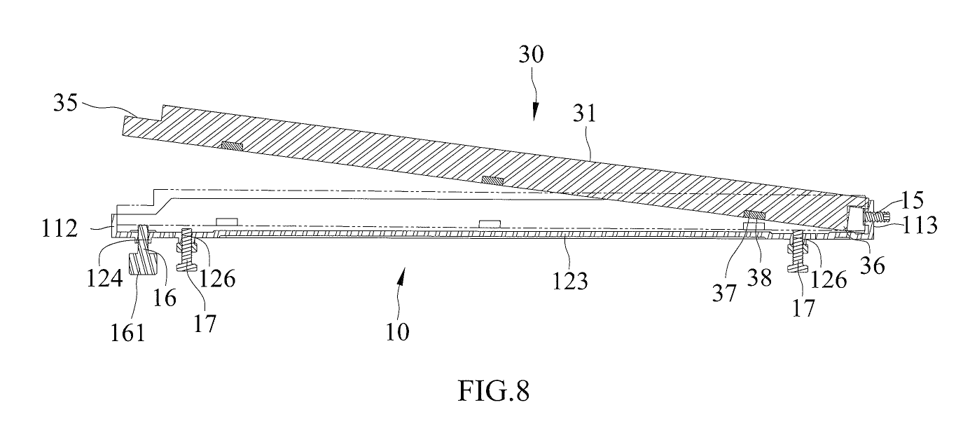

Each extended platform 30 further includes an inner lateral surface 32, an outer lateral surface 33 opposite to the inner lateral surface 32. The lateral surface 31 of one extended platform 30 is disposed corresponding to one lateral surface 22 of the platform 20 and the lateral surface 31 of the other extended platform 30 is disposed corresponding to the other lateral surface 22 of the platform 20. Each extended platform 30 also includes a front side 35 disposed adjacent to the front wall 112 and a back side (not numbered) disposed adjacent to the back wall 113, respectively. The front side 35 includes a top edge at a height lower than that of the top surface 31 and a side edge extending from the top surface top surface 31 to the top edge. The front side 35 allows a user to grasp when putting the extended platform 30 on the protective member 10. In addition, the outer lateral wall 33 and back side of each extended platform 30 include recessed areas 36 defined thereon, and each recessed area 36 defined on the outer lateral wall 33 is disposed corresponding to one aperture 114 defined in the lateral wall 111 of the frame 11 of the protective member 10 and allow the associated securing member 15 to fit within the periphery of the frame 11, and each recessed area 36 defined on the back side is disposed corresponding to one aperture 114 defined in the back wall 113 of the frame 11 of the protective member 10 and allow the associated securing member 15 to fit within the periphery of the frame 11. In the embodiment, each extended platform 30 includes two recessed areas 36 defined on the outer lateral wall 36 thereof FIG. 8 illustrates when installing the extended platform 30 its back side is first pushed against the back wall 113 of the frame 11 of the protective member 10 and its front side 35 is kept at a height above the protective member 10 at first. The front side 35 is then lowered to engage with the protective member 10. Additionally, the extended platform 30 would be buffered by the buffering member 16 before it contacts with the adjusting members 17 to avoid its weight affect the adjustment of the adjusting members 17 that enables the top surface 31 of extended platform 30 to be flush and level with the top surface 21 of platform 20.

FIG. 9 shows the worktable and its protective member 10 mounted on a pedestal 90 of a machine.

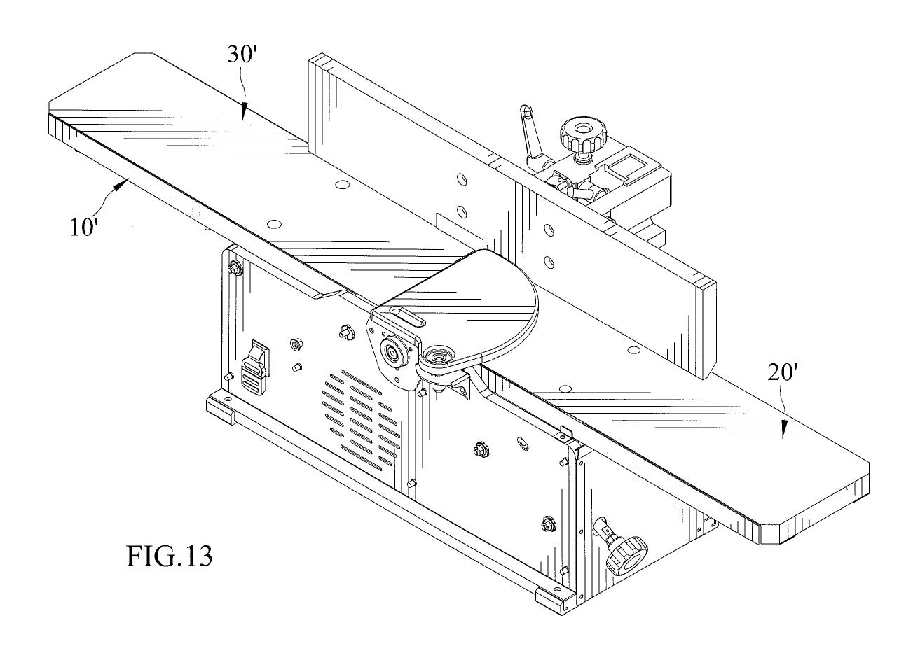

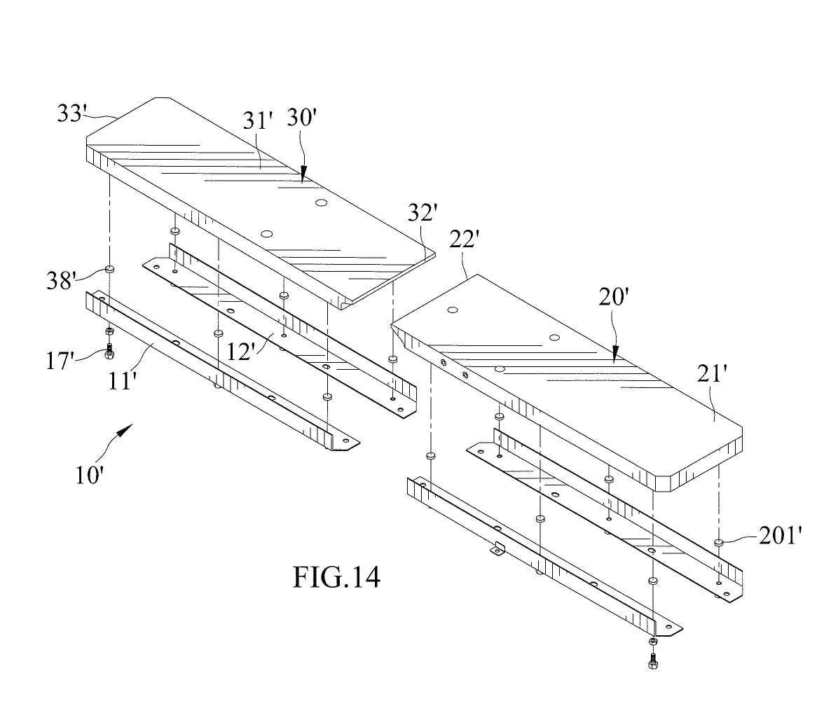

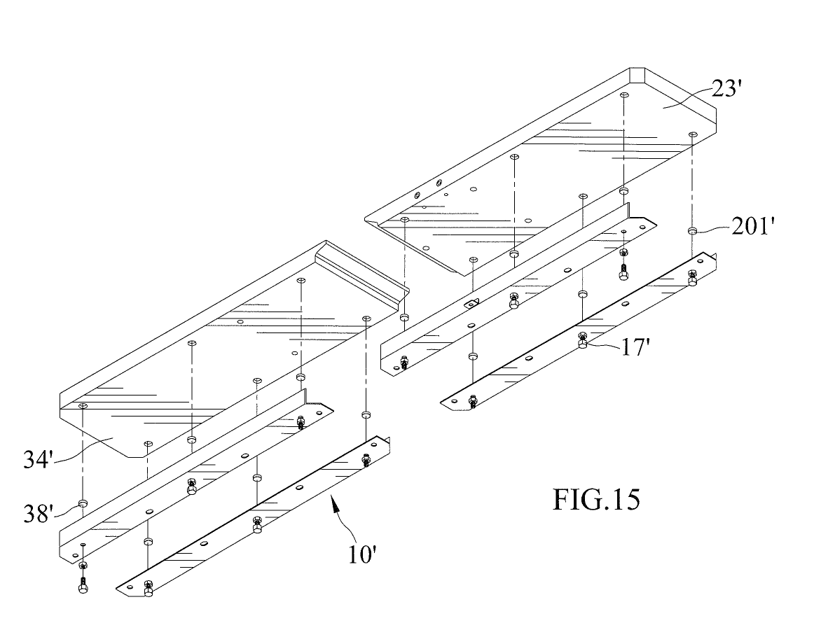

FIGS. 13 through 15 show a worktable including a protective member 10′ designed therefor in accordance with a second embodiment of the present invention. FIG. 13 also shows a machine, i.e. a jointer, including the worktable and its protective member 10′.

The worktable includes a platform 20′ and an extended platform 30′. The platform 20′ has a top surface 21′ defining a work surface and the extended platform 30′ has a top surface 31′ defining a work surface. The top surfaces 21′ and 31′ are at the same height such that they form a flat and level work surface. The platform 20′ also has a lateral surface 22′ defined thereon. The extended platform 30′ also has an inner lateral surface 32′ and an outer lateral surface 33′ defined thereon.

The protective member 10′ includes a frame 11′ and a base 12′ extended along a periphery and on a bottom edge of the frame 11′. Consequently, the frame 11′ has a top edge at a height above the base 12′. In addition, the protective member 10′ includes four sections separated from one another, with two sections associated with the platform 20′ the other two sections associated with the extended platform 30′. Likewise, the two bases 12′ of the two sections of the protective member 10′ associated with the platform 20′ are utilized to support the platform 20′ and the two the two bases 12′ of the two sections of the protective member 10′ associated with the extended platform 30′ are utilized to support the extended platform 30′. The platform 20′ includes a plurality of magnets 201′ embedded therein and provide for the platform 20′ magnetic attractions with the protective member 10′. Likewise, the extended platform 30′ includes a plurality of magnets 38′ embedded therein and provide for the extended platform 30′ magnetic attractions with the protective member 10′. It is understood that for each platform 20′ and each extended platform 30 the magnets 201′ and 38′ embedded therein can attract any metal part in connection with the protective member 10′ otherwise to retain the platform 20′ and extended platform 30′ to the protective member 10′.

In addition, the protective member 10′ includes a plurality of adjusting members 17′ adjustably engaged therewith to allow a user to adjust and make the top surface 31′ of extended platform 30′ flush and level with the top surface 21′ of platform 20′. Specifically, the adjusting members 17 are provided to abut against a bottom surface 23′ of the platform 20′ and a bottom surface 34′ of the extended platform 30′ plus the magnets 201′ and 38′ embedded in the platform 20′ and extended platform 30′.

In view of the forgoing, the protective member 10, 10′ can protect the worktable from being damaged or chipped by an external object. Furthermore, the buffering member 16 prevents the extended platform 30 from affecting the adjustment of the adjusting members 17. Moreover, the platform 20 and extended platforms 30 are prevented from moving relative to one another laterally by the securing members 15.

While the specific embodiments have been illustrated and described, numerous modifications come to mind without significantly departing from the spirit of invention, and the scope of invention is only limited by the scope of the accompanying claims.

What is claimed is:

1. A worktable with a protective member designed therefor comprising:
a platform including a top surface, a lateral surface, and a bottom surface;
at least one extended platform including a top surface, an inner lateral surface, an outer lateral surface and a bottom surface;
a frame and a base connected on a bottom edge of the frame;
a plurality of adjusting members adjustably engaged with the protective member; and
wherein the bottom surface of platform and the bottom surface of the extended platform are supported on the base; and
wherein the top surface of the at least one extended platform and the top surface of platform are at the same height such that the at least one platform cooperates with the platform to form a flat and level work surface, and with the at least one extended platform being adjustable in height by the plurality of adjusting members to enable the top surface thereof being flush and level with the top surface of platform.

2. The worktable and the protective member designed therefor as claimed in claim 1, wherein the base includes a first through hole, at least one second through hole and at least one third through hole defined therein, and the first through hole includes a buffering member adjustably engaged therein, and each of the at least one second and third through holes includes one of the plurality of adjusting members adjustably engaged therein, and wherein the buffering member serves to buffer the at least one extended platform and to avoid a weight of the at last one extended platform affecting the adjustment of the adjusting members, and the adjusting members are utilized to enable the top surface of the at least one extended platform to be flush and level with the top surface of platform.

3. The worktable and the protective member designed therefor as claimed in claim 1, wherein the at least one extended platform includes at least one magnet embedded therein to magnetically attract with the protective member for holding the at least one extended platform of worktable on the protective member.

4. The worktable and the protective member designed therefor as claimed in claim 3, wherein the platform includes at least one magnet embedded therein to magnetically attract with the protective member for holding the at least one extended platform of worktable on the protective member.

5. The worktable and the protective member designed therefor as claimed in claim 2, wherein the at least one extended platform includes at least one magnet embedded therein to magnetically attract with the protective member for holding the at least one extended platform of worktable on the protective member.

6. The worktable and the protective member designed therefor as claimed in claim 5, wherein the platform includes at least one magnet embedded therein to magnetically attract with the protective member for holding the at least one extended platform of worktable on the protective member.

7. The worktable and the protective member designed therefor as claimed in claim 1 further comprising a reinforcing rib provided on the protective member to enhance the structure thereof, with the reinforcing rib extending between peripheral sides of the frame.

8. The worktable and the protective member designed therefor as claimed in claim 1, wherein the frame includes a plurality of apertures defined therein, and each of the plurality of apertures includes a securing member inserted therethrough, and wherein the platform and the at least one extended platform are abutted by the plurality of securing members such that they are fit within the protective member securely and are prevented from moving relative to one another.

9. The worktable and the protective member designed therefor as claimed in claim 2, wherein the frame includes a plurality of apertures defined therein, and each of the plurality of apertures includes a securing member inserted therethrough, and wherein the platform and the at least one extended platform are abutted by the plurality of securing members such that they are fit within the protective member securely and are prevented from moving relative to one another.

10. The worktable and the protective member designed therefor as claimed in claim 3, wherein the frame includes a plurality of apertures defined therein, and each of the plurality of apertures includes a securing member inserted therethrough, and wherein the platform and the at least one extended platform are abutted by the plurality of securing members such that they are fit within the protective member securely and are prevented from moving relative to one another.

11. The worktable and the protective member designed therefor as claimed in claim 5, wherein the frame includes a plurality of apertures defined therein, and each of the plurality of apertures includes a securing member inserted therethrough, and wherein the platform and the at least one extended platform are abutted by the plurality of securing members such that they are fit within the protective member securely and are prevented from moving relative to one another.

12. The worktable and the protective member designed therefor as claimed in claim 8, wherein each of the platform and the at least one extended platform includes a recessed area disposed corresponding to one aperture and the securing member inserted in the associated aperture is received in the recessed area and is adapted to fit within the periphery of the frame such that it does not expose outside the periphery of the frame.

13. The worktable and the protective member designed therefor as claimed in claim 1, wherein the platform further includes a channel defined therein and disposed adjacent to the lateral surfaces, and the channel includes a lateral edge and a bottom edge, and the bottom edge is at a height lower than that of the top surface of platform, and the lateral edge extends from the top surface to the bottom edge, and the bottom edge extends from the lateral edge to the lateral surface, and the channel is adapted to enable a protractor moveably mounted therein.

14. The worktable and the protective member designed therefor as claimed in claim 2, wherein the platform further includes a channel defined therein and disposed adjacent to the lateral surfaces, and the channel includes a lateral edge and a bottom edge, and the bottom edge is at a height lower than that of the top surface of platform, and the lateral edge extends from the top surface to the bottom edge, and the bottom edge extends from the lateral edge to the lateral surface, and the channel is adapted to enable a protractor moveably mounted therein.

15. The worktable and the protective member designed therefor as claimed in claim 3, wherein the platform further includes a channel defined therein and disposed adjacent to the lateral surfaces, and the channel includes a lateral edge and a bottom edge, and the bottom edge is at a height lower than that of the top surface of platform, and the lateral edge extends from the top surface to the bottom edge, and the bottom edge extends from the lateral edge to the lateral surface, and the channel is adapted to enable a protractor moveably mounted therein.

16. The worktable and the protective member designed therefor as claimed in claim 5, wherein the platform further includes a channel defined therein and disposed adjacent to the lateral surfaces, and the channel includes a lateral edge and a bottom edge, and the bottom edge is at a height lower than that of the top surface of platform, and the lateral edge extends from the top surface to the bottom edge, and the bottom edge extends from the lateral edge to the lateral surface, and the channel is adapted to enable a protractor moveably mounted therein.

17. The worktable and the protective member designed therefor as claimed in claim 1, wherein the platform includes a slot defined in the top surface, and the slot includes a table insert embedded and detachably secured therein such that the table insert is able to be disengaged therefrom with the use of any tool, and wherein the table insert includes a top being flush and level with the top surface of platform.

18. The worktable and the protective member designed therefor as claimed in claim 17, wherein the slot includes a supporting portion that supports the table insert, and an opening that is adapted to allow a cutting member of the cutting device to insert through and expose outside the table insert, and the supporting portion includes a fixing seat mounted thereon and disposed between a bottom of the table insert and a top of the associated supporting portion, and the fixing seat includes at least one magnet embedded therein, and the table insert includes at least one regulating member adjustably embedded therein and attracted by the at least one magnet for holding the table insert in the slot, and the regulating member is adjusted to enable the top of table insert being flush and level with the top surface of platform.

19. The worktable and the protective member designed therefor as claimed in claim 2, wherein the platform includes a slot defined in the top surface, and the slot includes a table insert embedded and detachably secured therein such that the table insert is able to be disengaged therefrom with the use of any tool, and wherein the table insert includes a top being flush and level with the top surface of platform.

20. The worktable and the protective member designed therefor as claimed in claim 19, wherein the slot includes a supporting portion that supports the table insert, and an opening that is adapted to allow a cutting member of the cutting device to insert through and expose outside the table insert, and the supporting portion includes a fixing seat mounted thereon and disposed between a bottom of the table insert and a top of the associated supporting portion, and the fixing seat includes at least one magnet embedded therein, and the table insert includes at least one regulating member adjustably embedded therein and attracted by the at least one magnet for holding the table insert in the slot, and the regulating member is adjusted to enable the top of table insert being flush and level with the top surface of platform.
